(19) United States
(12) Patent Application Publication
(10) Pub. No.: US 2001/0034646 A1
(43) Pub. Date: Oct. 25, 2001

(54) System and method for creating a web page return link

(76) Inventors: Edward G. Hoyt, Scottsdale, AZ (US); John G. Hoyt, Tempe, AZ (US); Timothy D. Peterson, Lockhart, TX (US); William P. Alyea, Gilbert, AZ (US)

Correspondence Address: Howard I. Sobelman, SNELL & WILMER, L.L.P., One Arizona Center, 400 East Van Buren, Phoenix, AZ, 85004-2202, US

(21) Appl. No.: 09/769,875

(22) Filed: Jan. 25, 2001

Related U.S. Application Data
(60) Provisional application No. 60/178,260, filed on Jan. 25, 2000.

(51) Int. Cl. G06F 17/60

(52) U.S. Cl. 705/14

(57) ABSTRACT

A system and method is disclosed for extending the visual presence of a web site on the next visited site. Users view pages from RLS member web sites over the Internet. As the user clicks on a link from one member web site to a host member web site, the user views icons, logos, and other text and indicia from the sponsoring member web site. These logos and other indicia may also function as dynamic links returning the user to the referring web site. In this manner, advertising on host web sites can be targeted to users based on where the user came from. The RLS system further includes a search engine which can link all members of the RLS system and automatically create affiliations for advertising and unused web space. Therefore, the return link system encourages referrals, makes advertising more efficient, and encourages and simplifies business affiliation. The RLS system may further simplify browsing for users making it possible to return to web sites that were visited earlier in a session or in a previous session. The RLS system also provides a way for compensation to be paid to referring web sites, allows participation of non-web based participants, and identifies affiliates for preferential treatment.

### CROSS REFERENCE TO RELATED APPLICATION

This Application claims the benefit of, and priority to, provisional application Ser. No. 60/178,260, filed Jan. 25, 2000, which is hereby incorporated by reference in its entirety.

### TECHNICAL FIELD OF THE INVENTION

The present invention relates generally to Internet advertising and, more particularly, to the creation of a referral system encouraging advertising and referrals over the Internet, extending the visual presence of a web site on the next visited site, creating dynamic links back to referral sites, creating a methodology to allow instantaneous referral commission affiliation between known or unknown web sites, and promoting ease of navigation for users on the Internet.

### BACKGROUND OF THE INVENTION

Electronic commerce has rapidly become a major business tool in recent years. High-speed Internet access, faster computers, and the wide variety of products available on the Internet have lead to the success and general acceptance of purchasing products over the Internet. When using the Internet, consumers may find items and purchase those items on-line, by telephone, or through the mail.

Advertising is a common method for companies to obtain customers. With the increased popularity of electronic commerce, Internet advertising has experienced rapid growth and is widely used on many web sites. However, Internet advertising has experienced many of the same difficulties common to conventional advertising methods such as magazines, newspapers, and television. One of these difficulties is the inability to accurately target the advertising to people who are most likely to be affected by the advertising. While it is possible to make some generalizations about the people who will be watching, reading or listening to a program, due to the varying interests of the audiences, it is difficult to verify that each person who sees or hears an advertisement is at all interested in that product. Similarly, Internet advertisers often understand that many people browsing the web may have little interest in the content that scrolls across the top of their screen.

In addition to advertising, referrals are another common method for companies to obtain customers. The use of referrals has similarly expanded in the electronic commerce market. For example, many web sites provide connections to other commerce web sites which are commonly known as “links” and clicking on a link will take the user to the referred web site. As such, referrals increase traffic to a web site. Even high traffic web sites that do not sell goods may enjoy financial success due to the sale of advertising space, thus making referrals valuable to that type of web site. Furthermore, web sites that link to other commercial web sites may have a financial arrangement where the referring web site can be reimbursed monetarily for the referral. This reimbursement can come in the form of a fee per “impression”; where a set fee is paid every time a user on the Internet views the advertisement/link to the second web site. The reimbursement may also come in the form of a fee or commission which is paid only when an Internet user “clicks through” to the second web site. In another reimbursement model, a commission or fee is paid to the referring site for each sale that is made on the referred web site. Examples of reimbursement systems can be found in U.S. Pat. No. 6,009,412, Fully Integrated On-Line Interactive Frequency And Award Redemption Program, and U.S. Pat. No. 5,855,008, Attention Brokerage, both of which are incorporated herein by reference.

Although advertising and referrals are good tools for attracting business and increasing sales, many non-commercial endeavors benefit from the use of advertising and referrals. For example, non-profit informational web sites will often link to other sources of information as a means of proliferating information and simplifying searching. Other non-profit web sites may provide referrals to affiliates/members to promote common social, philosophical, or political goals.

Although linking and referring customers is widely practiced, there are several significant drawbacks which hinder expanded development of customer referrals on the web. One of these drawbacks is that web site owners are concerned that once a user at their web site clicks a link to another web site, that user may never return to the referring web site. For example, the user may forget the name of, or location of, the referring web site. Furthermore, after a protracted Internet session, it may be difficult to click backwards to the referring web site or it may be too difficult to find the web site using other techniques such as, for example, reviewing the history in the browser.

Additional drawbacks of referrals are that it is difficult to create affiliations between web site owners. This is particularly true when agreements must be reached about the commission, fee, or royalty to be paid for each link to another web site. Furthermore, the referral system suffers from many of the same difficulties associated with non-Internet referral systems, namely, it is difficult to insure the accuracy of where the referral came from; it is cumbersome for the consumer and/or merchant to report or process the referral properly; and, it is burdensome to entice others to make those referrals. Therefore, a need exists for a return link system (RLS) which addresses the difficulties of Internet advertising and referral systems.

### SUMMARY OF THE INVENTION

An integrated data base and information server are provided that effectively create a return link system providing an improved Internet advertising and referral system. A user at a first web site can click on a link to a second web site which has allocated space for advertising by the first web site and links back to the first web site. The Internet user may browse multiple pages within the second web site, yet will continue to see indicia such as the logo, advertisement, additional message line(s), and/or links back to the first web site; thus, effectively extending the session presence of the first web site to include all of the time the user is browsing at the second web site. In another embodiment, any purchases made at the second web site may result in compensation that is directed back to the owner of the first web site.

In another embodiment, the user can continue from the second web site to a third web site and to an N^{th} web site and continue to have one or more return links available to direct the user back to the referring web site. In a further embodiment, the return link system provides the return link logo, advertising, and links in future browsing sessions when the user returns to a previously visited web site. In further embodiments, an automatic dynamic affiliation system is included allowing web site owners to affiliate to known or unknown other web site owners and to reimburse each other for referrals according to pre-established criteria and filters of their choice.

The Return Link System is a very useful tool to encourage referrals, make advertising more efficient, simplify and encourage business affiliation, simplify browsing for users, extend session presence for web site owners, increase compensation to referring web sites, allow participation of non-web based participants, and identify affiliates for preferential treatment.

### BRIEF DESCRIPTION OF THE DRAWINGS

The above and other features and advantages of the present invention are hereinafter described in the following detailed description of illustrative embodiments to be read in conjunction with the accompanying drawing figures, wherein like reference numerals are used to identify the same or similar parts in the similar views and:

FIG. 1 is a block diagram of an exemplary return link system;

FIG. 2 is a flow diagram illustrating exemplary logic, from a users perspective, performed in accordance with an exemplary embodiment of the present invention;

FIG. 3 is a flow diagram illustrating exemplary logic, from a commercial web site perspective, performed in accordance with an exemplary embodiment of the present invention;

FIG. 4a is an exemplary screen shot showing a non-host web site of an RLS member with a banner advertisement sponsored by a host member web site;

FIG. 4b is an exemplary screen shot showing a host site and advertisement such as a logo of a referring member;

FIG. 4c is an exemplary screen shot of a subsequent page within said host site as a user browses a host site;

FIG. 4d is an exemplary screen shot of a check-out web page for assisting a user in purchasing a product from a host site;

FIG. 4e is an exemplary screen shot of a designated return page within a non-host referring member site;

FIG. 5 is an exemplary screen shot of an entry page for an affiliate program;

FIG. 6 is an exemplary screen shot of a web page for a member newsletter; and,

FIG. 7 is an exemplary screen shot of a web page for updating a member's profile.

### DETAILED DESCRIPTION OF EXEMPLARY EMBODIMENT

The present invention may be described herein in terms of functional block components, screen shots, optional selections, and various processing steps. It should be appreciated that such functional blocks may be realized by any number of hardware and/or software components configured to perform the specified functions. For example, the present invention may employ various integrated circuit components, e.g., memory elements, processing elements, logic elements, look up tables and the like, which may carry out a variety of functions under the control of one or more micro processors or other control devices. Similarly, the software elements of the present invention may be implemented with any programming or scripting language such as C, C++, JAVA, COBOL, ASSEMBLER, PERL, or the like, with the various algorithms being implemented with any combination of data structures, objects, processes, routines or other programming elements. Further, it should be noted that the present invention may employ any number of conventional techniques for data transmission, signaling, data processing, network control, and the like. Still further, the inventions could be used with a security device or scripting language, such as JAVASCRIPT, VBSCRIPT, or the like.

It should be appreciated that the particular implementations shown and described herein are illustrative of the invention and its best mode and are not intended to otherwise limit the scope of the present invention in anyway. Indeed, for the sake of brevity, conventional data networking, application development, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical return link system.

To simplify the description of the exemplary embodiments, the invention is frequently described as pertaining to an Internet return link system, or to an Internet advertising and referral system. It will be appreciated, however, that many applications of the present invention could be formulated. One skilled in the art will appreciate that the network may include any system for exchanging data or transacting business, such as the Internet, intranet, extranet, WAN, LAN, satellite communications, cell phones, and/or the like. The users may interact with the system via any input device such as a keyboard, mouse, kiosk, personal digital assistant, hand-held computer (e.g., Palm Pilot ®), cellular phone and/or the like. Similarly, the invention could be used in conjunction with any type of personal computer, network computer, work station, minicomputer, main frame, or the like running any operating device, such as any version of Windows, Windows NT, Windows 2000, Windows 98, Windows 95, Mac OS, OS/2, BeOS, LINUX, UNIX, or the like. Moreover, although the invention is frequently described herein as being implemented with TCP/IP communications protocols, it will be readily understood that the invention could also be implemented using IPX, Appletalk, IP-6, NetBIOS, OSI or any number of existing or future protocols. Moreover, while the exemplary embodiments will be described as a return link system, the system contemplates the use, sale or distribution of any goods, services, or information over any network having similar functionality described herein.

The user and the web site owner may represent individual people, entities, or businesses. It is further noted that other participants may be involved in some phases of the transaction, and/or browsing, such as processing companies, clearinghouses, loyalty companies, incentive companies and/or the like, but these participants are not shown. Each participant is equipped with a computing system to facilitate online commerce transactions or other browsing. The user interfaces with a “user system” such as a computing unit in the form of a personal computer, although other types of computing units may be used, including laptops, notebooks, hand-held computers, mobile phones, cellular phones, set-top boxes, and the like. The web site owner has a computing unit implemented in the form of a computer-server, although other implementations are possible.

The computing units are connected with each other via a data communication network. The network may be a public network and thus assumed to be insecure and open to eavesdroppers. In the illustrative implementation, the network is embodied as the Internet. In this context, the computers may or may not be connected to the Internet at all times. For instance, the customer computer may employ a modem to occasionally connect to the Internet, whereas the electronic commerce web site owners may maintain a permanent connection to the Internet. It is noted that the network may be implemented as other types of networks, such as an interactive television (ITV) network.

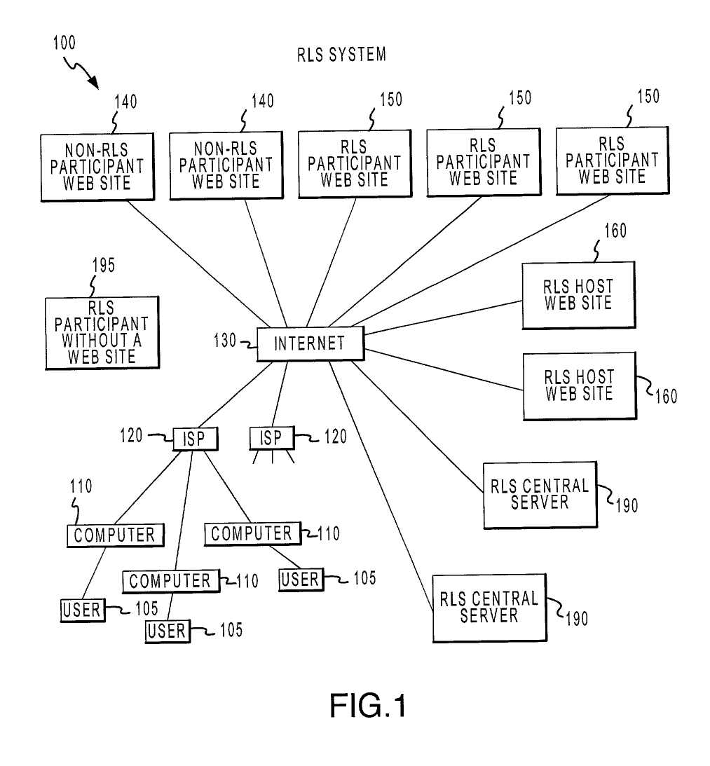

Referring now to FIG. 1, a return link system 100 suitably includes at least one user computer 110, at least one Internet service provider (ISP) 120, an Internet 130, at least one non-RLS participant web site 140, and at least one participant RLS web site 150. In various embodiments described in detail herein, the RLS system 100 is used in electronic commerce for advertising and referrals. A user 105 may be a customer, a shopper, or simply a person browsing the web. User 105 operates a computer 110. Computer 110 is connected to an Internet 130 via an Internet service provider 120.

The various computer systems and servers are suitably interconnected by a data network or Internet 130, which is any data network such as the Internet or another public data network. Other suitable networks 130 include the public switched telephone network (PSTN), corporate or university intranets, and the like. In various embodiments not shown, computer 110 may be electronically coupled to a server (not shown) to a data connection separate from the network. Exemplary data connections suitable for alternative use with the present invention include telephone connections, modem, ISDN connections, dedicated T1 or other data connections, wireless connections and the like. To connect to other web sites connected to the Internet 130, the user 105 suitably establishes a connection through the Internet 130 to a web site (e.g., 140 or 150). The non-RLS participant web site 140 is any web site which is not affiliated with the RLS system and not registered by members of the RLS system. An RLS participant web site 150 is any web site where the owner of the web site has taken actions to participate in the RLS system.

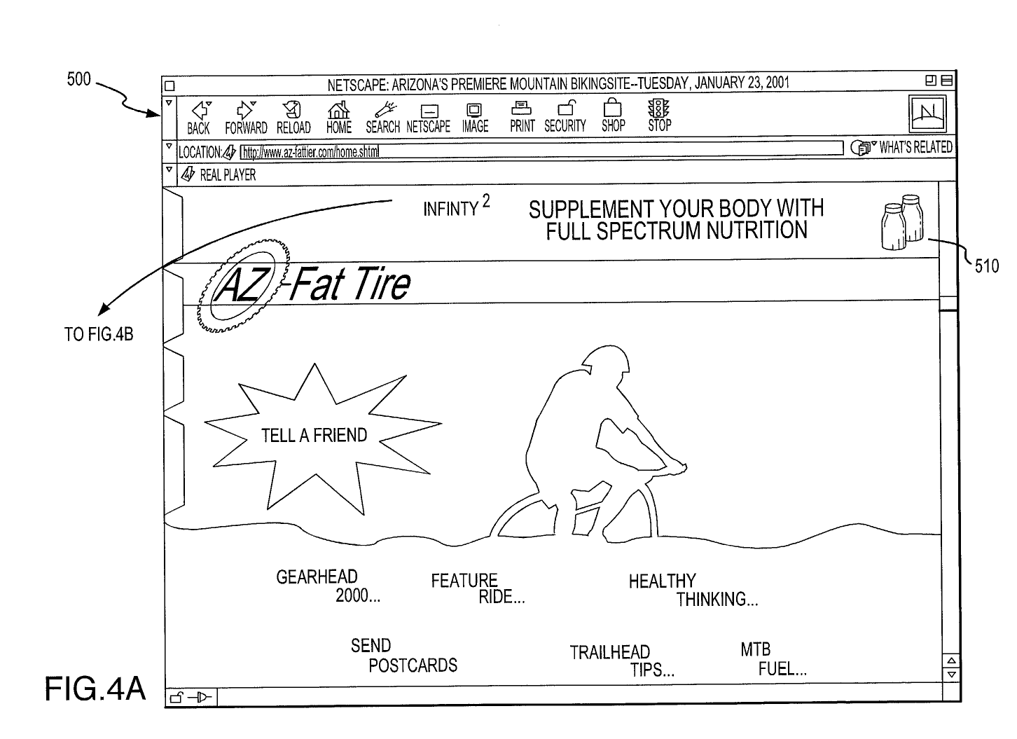

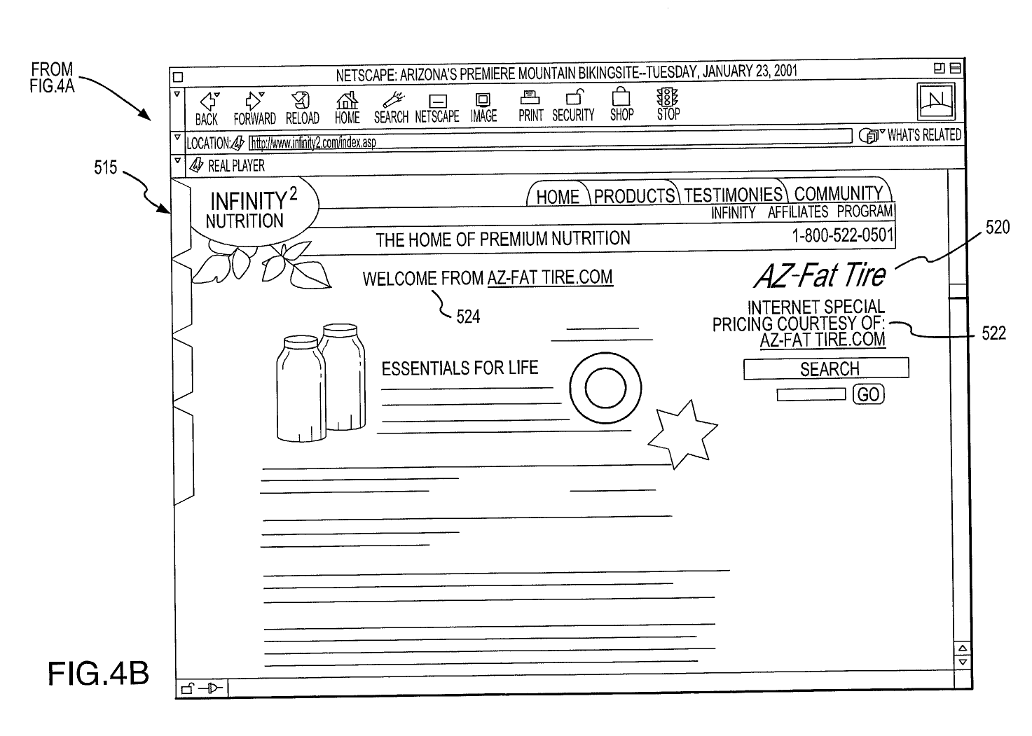

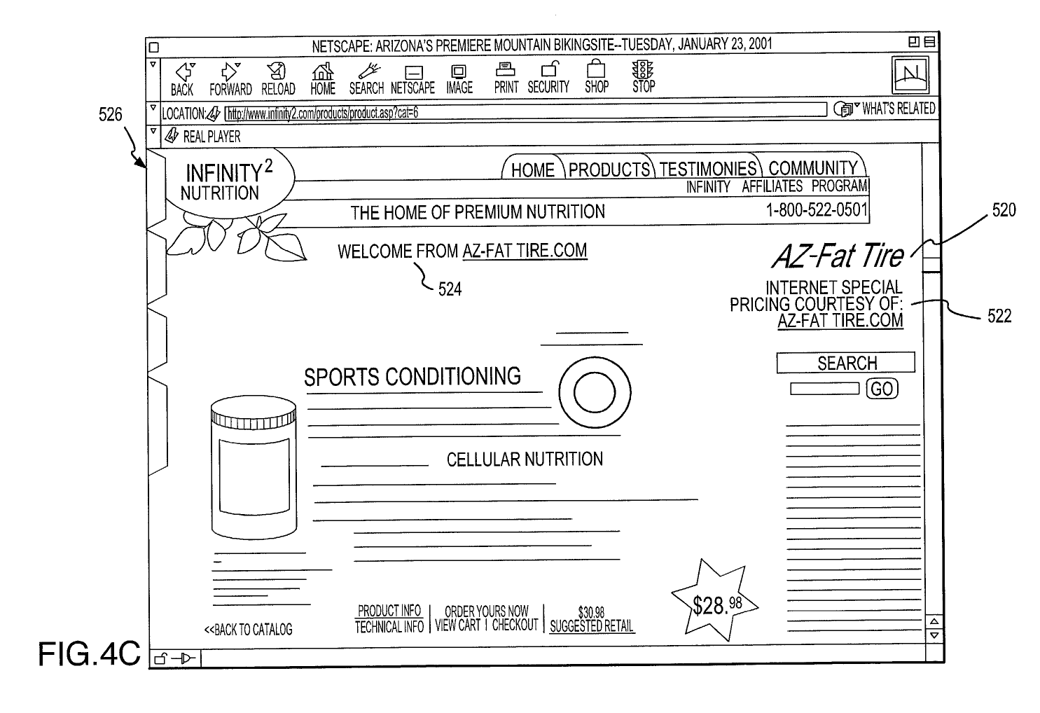

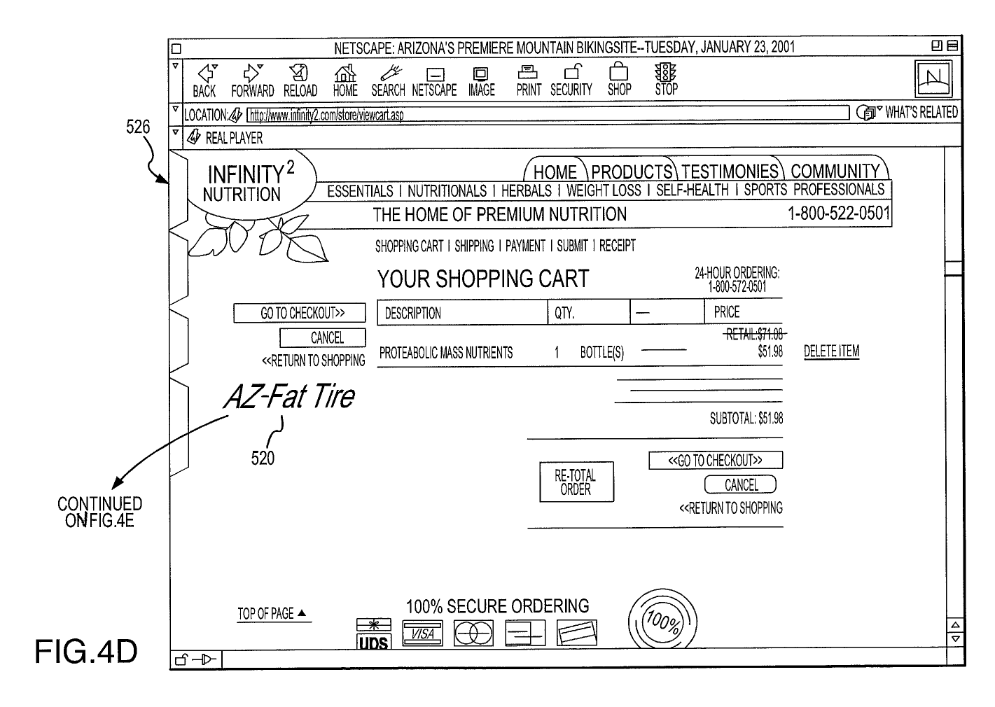

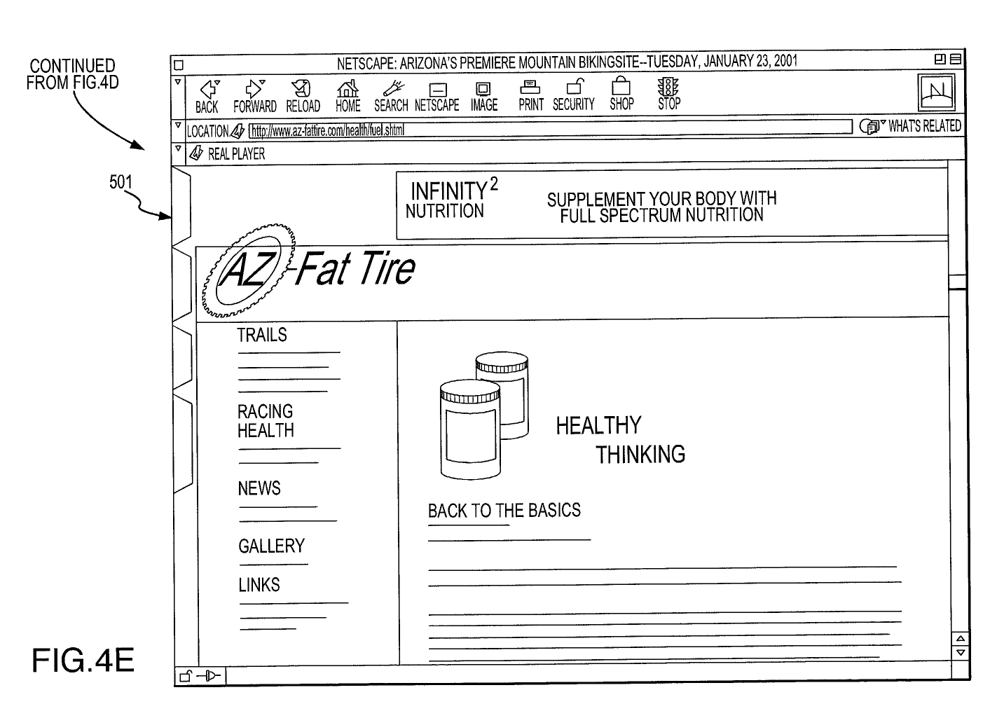

The pages are web pages using Hyper Text and Markup on Language (HTML) which are transmitted to a user 105 from a web site 140 or 150 over the Internet 130 using the HTTP protocol. Screenshots of exemplary embodiments of web pages are shown in FIGS. 4-7. A browser, such as Netscape Navigator® or Microsoft Internet Explorer®, is used to view the web pages. It will be appreciated that the invention can be used to read information and formats other than HTML, for example, Extensible Markup Language (XML) or Wireless Markup Language (WML). It will also be appreciated that the information can be communicated using protocols other than HTTP, for example, Wireless Access Protocol (WAP).

The model of a web site effectively consists of a collection of pages. Each page has an associated vector that characterizes its fields and navigational options (for example, links to other pages, such as a home page or a check out page within a merchant site). The binding of a set of values to these vectors prescribes a specific interaction with the site model. It will be appreciated that this description assumes a specification of the starting page for the interaction, and facilities for managing cookies, SSL connections, and any other activities that might be part of the typical user interaction using a browser (which might include Java script, Java, ActiveX, and other functionality). In various embodiments, the member profile database and other databases may be a relational database, a Lightweight Directory Access Protocol (LDAP), or some other type of database.

An RLS Member is a person, company, web site or any other entity that participates in the RLS system. RLS Members have signed up to participate in the RLS system, typically through connecting to the RLS central server and providing the requisite information. In other embodiments, the registered members may sign up to participate in the RLS system by telephone, mail, or other like methods.

Registered members may have a host web site, a non-host web site, or no web site at all. A registered member with a host site (e.g. 515) has access to all of the features of the RLS system, most notably, the ability to display the logo(s) (e.g. 520), custom greeting (e.g. 524), and additional message line(s) (e.g. 522) as shown in screen shots of an exemplary embodiment in FIGS. 4b and 4c. One or more of the logo(s), custom greeting, and additional message line(s) may operate as a return link to the referring web site.

With reference to FIG. 4a in an exemplary embodiment, a registered member with a non-host web site (e.g. 500), by contrast, is not configured to show the logo, custom greeting, or additional message line(s) of referring members. The non-host web site also is not configured to perform the return link function leaving referred computer users to find their own way back to the referring web site. However, the non-host web site can take advantage of other benefits of the return link system. For example, the non-host web site can participate in the instant affiliate program and take advantage of return links from host web sites. Importantly, the non-host web site can create an extended session presence by showing the non-host member's logo on all host sites that the non-host web site refers a user to visit.

The host web site and the non-host web site are collectively known as member sites and will be referred to as such herein. These member sites contain code that carries out or implements RLS functions. In one embodiment, the code could be a “component” such as ActiveX, COM Object, Dynamic Link Library, EXE, or other code encapsulating methods. Referring again to FIG. 1, in one embodiment, the code or component may reside at the RLS central server 190 or any other suitable server, as opposed to residing on the web sites (150 or 160), to be accessed at the RLS central server 190 as needed.

As mentioned above, it is possible for a registered member to not have a web site or to not affiliate a web site with the RLS system (see e.g. 195). In this embodiment there would be no return link because there is no web page to return to. However, a registered member without a web site can still advertise on host web sites 160 to the extent that the registered member referred users to that host web site 160. In one embodiment, a RLS participant without a web page could e-mail advertisements to a group of recipients and include in this e-mail a hyperlink or URL address or similar referral. Other embodiments also contemplate that radio, T.V., newspapers and other forms of communication could be used to encourage recipients and members of the public to visit a host web site 160. These solicitations could further include a referral number or validation number which can be recognized by the RLS system to verify the source of the referral and then display the appropriate logo and advertisement on behalf of the referring entity, as well as appropriately credit that entity for any sales that arise as a result of the referral. Furthermore, a registered member without a web site could participate in the RLS system by advertising on a RLS host site whenever available space arises and as selected by the instant affiliate program described herein.

In another embodiment, an RLS Member with a web site (150 or 160) is not registered with a central server or through any other means as a participant in the RLS system. Nonetheless, this member may configure their web site (150 or 160) to respond to RLS system commands. For example, a the member's web site (150 or 160) may be configured to respond to RLS searches, provide return link information, provide logo and advertising information, and in general communicate all necessary information with the RLS system. This member's web site (150 or 160) is configured to work with the RLS system by inserting metatags into the web site (150 or 160). Metatags are hidden text/code that is recognized by search engines and browsers.

RLS system metatags conform to a standard metatag style which may be unique to the RLS system. Therefore, an RLS metatag database is stored at the central server providing RLS metatags for copying with descriptions of the function and purpose of each metatag. Through the use of metatags, a non-registered member codes into their web page some or all of the same information a registered member would provide directly to the central server. An RLS search engine can perform, as one of its functions, an internet search for web pages with RLS metatags and can thus populate the RLS databases with the information found on the member web sites (150 or 160). Therefore, a non-registered member may experience many or all of the same features as a registered member.

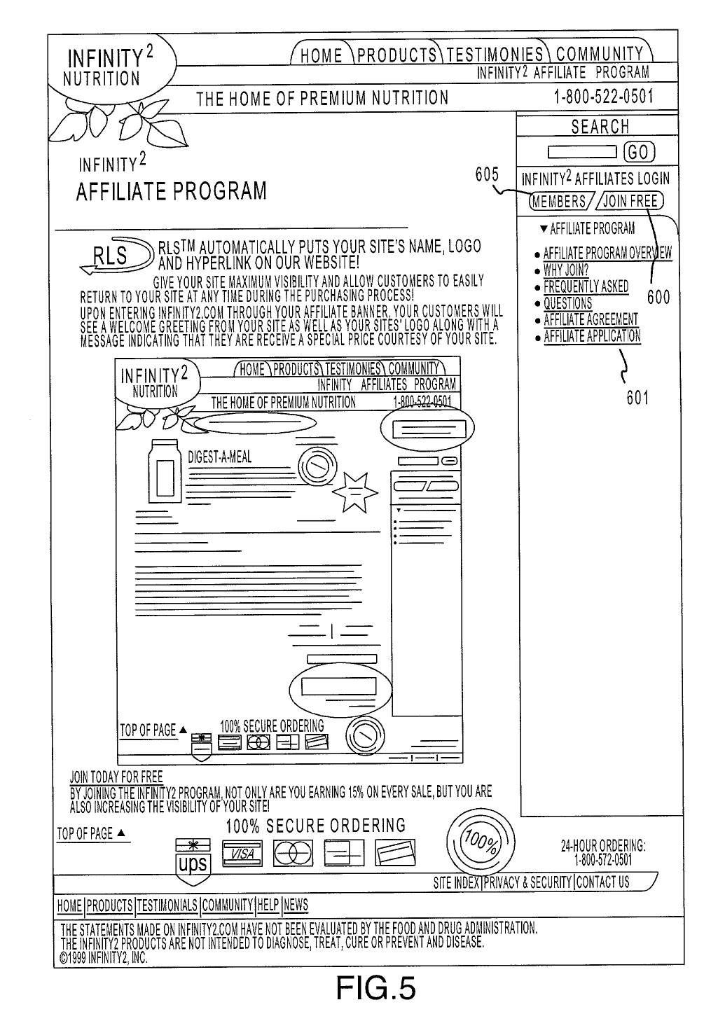

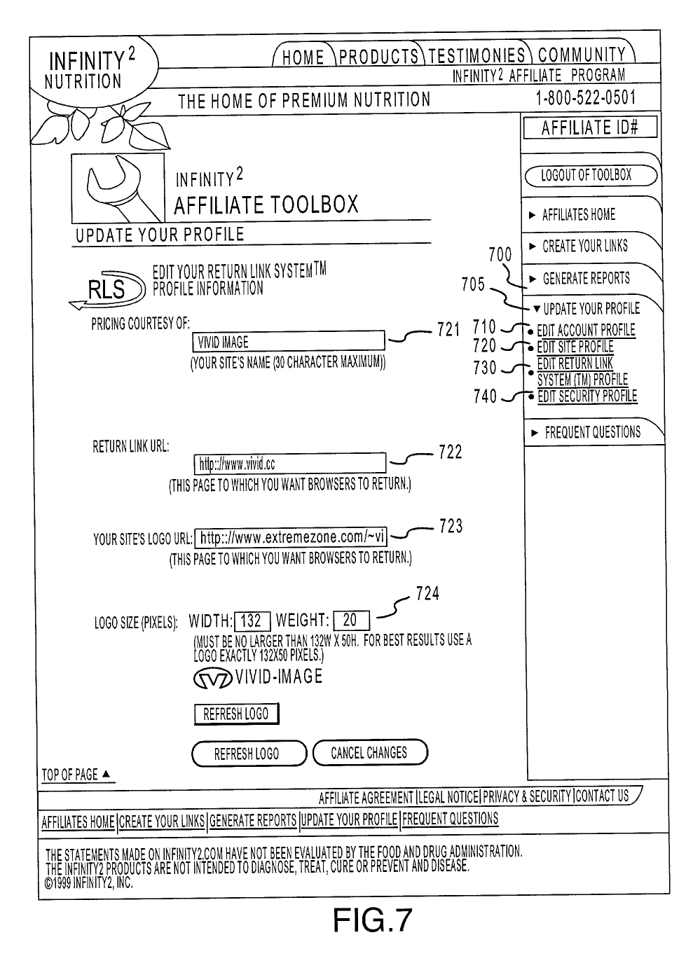

The RLS central server 190 contains an RLS search engine, and RLS metatag database, an RLS central repository, and a RLS database for demographics/history. The RLS central repository contains, among other things, a world wide logo and name registry, and profile information provided by members. In one embodiment of the present invention, potential members may sign up to become members (see e.g., 600 and 601 of FIG. 5) by interacting with the RLS central server. Furthermore, current members may change their individual profiles (see e.g., 605 of FIG. 5, 705, 710, 720 of FIG. 7) by modifying data stored in the world wide logo and name registry in the RLS central repository.

An exemplary process for registering as a member of the RLS system will now be described. The interested web site owner may browse the Internet to find a host web site, in communication with a central server, to sign up for membership on the RLS system (see e.g. 600, 601 of FIG. 5). Referring now to FIG. 7, the sign-up process includes the potential member providing identifying information and indicating whether the potential member wishes to operate a host web site, non-host web site, or without a web site. The potential member may also provide the following information (where applicable): a additional message line name/reference (e.g. 721), a return link URL address (e.g. 722), the URL address of a logo identifying the potential member (e.g. 723), the logo size (e.g. 724), and other information described herein. The member may specify the locations where the user should return back to their web site, including multiple return points as described below. The new members or members updating their profile may determine where on each of their web pages the referral logo and other objects will be displayed, thereby reserving out a piece of web site real estate for the display of the logo, greeting, and additional message line. The members may indicate the color, sound and design of the logo by indicating the storage location of the logo (e.g. 723) If the user does not want to or is not able to create a logo, the central server contains a dynamic logo creation tool which can create a logo for the new member or the member editing their profile.

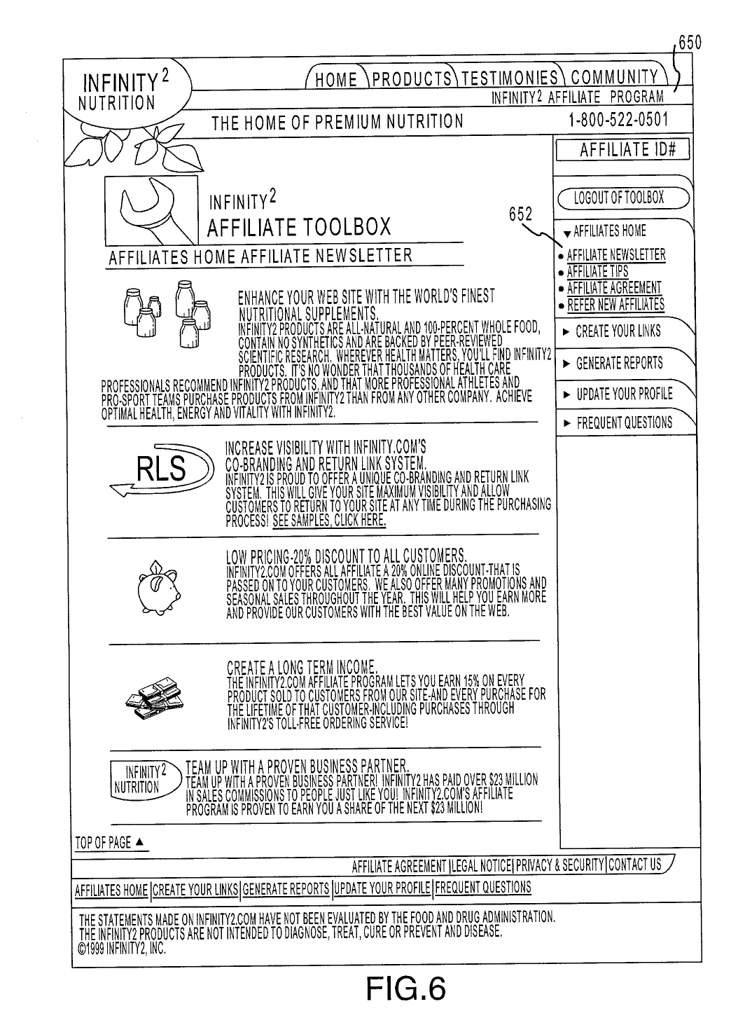

This process establishes a profile for the new member and provides an ID number to the new member with an appropriate password. This process also allows the new member to indicate whether the member wishes to participate in an Instant Affiliates program (e.g. 650, FIG. 6) and, if so, whether the new member wishes to disallow particular sites or disallow particular site types from its Instant Affiliate program. The Instant Affiliate options also allow the new member to select options related to reimbursing referral web sites after a sale, and to select options relating to the use of blank advertising space when a referring web site is a disallowed web site. As mentioned above, a registered member can return to the profile section at any time to update this information (see e.g. screenshot 605, FIG. 6).

A member may also select from options for the use of blank advertising space that would otherwise exist when a user enters the web site from a non-participant web site. These options may include, among other embodiments, use of the blank advertising space by other objects on the member's web page, advertising via the Instant Affiliates program, or advertising for merchants independent of the RLS system. Furthermore, the member may choose to filter or block specific sites/site types/members/member types from displaying RLS logos and links on the member's host site. This allows a member to avoid affiliation with, for example, low quality goods, direct competitors, or sites of a questionable reputation or harmful nature.

RLS central server 190 (FIG. 1) contains an RLS search engine. The RLS search engine could be used in a similar manner as other well known search engines, such as Google® and Yahoo®, which locate web sites that contain particular information, however, in an exemplary embodiment, the RLS search engine gives priority to RLS Member sites. In another embodiment, the RLS search engine is used as a tool in facilitating the ranking of web sites by search engines, such as Yahoo, wherein the RLS codes in the RLS Member web site could be used as another factor that the other search engines use in weighting and ranking the found web sites. This approach is similar to one taken by RealNames™ which is more fully described in a patent assigned to RealNames™, U.S. Pat. No. 6,151,624 incorporated by reference. Further information about RealNames may be found on the web at http://web.realnames.com/Eng/Eng_Corporate_RealNamesHomepage. asp.

The RLS search engine in another embodiment is used to find advertising for the instant affiliate program in the RLS system. A member participating in the Instant Affiliate program can choose to have the RLS system select advertisers from the RLS membership based on filtering and prioritizing criteria. The Instant Affiliate member can exclude specific sites and types of sites from advertising on the member's web site. The Instant Affiliate member can also prioritize advertisers based on criteria such as geographic limitations, volume of traffic experienced at the advertising site, product type, company name, best price available for consumers as advertised, best commission to referring web site 160, etc. A “customized Instant Affiliate autoscan” is performed by the RLS search engine to locate advertisers that best meet the criteria selected by the Instant Affiliate member. The instant affiliate program provides a way for businesses with no direct affiliation with one another to quickly become dynamically affiliated through the RLS worldwide affiliation database. For example, if a host web site 160 has advertising space that is not being used, the instant affiliate program can search the RLS central server databases using criteria specified by the host web site 160 to find the best advertising affiliate for their web site 160. Both the advertisers and the host web sites 160 participating in the instant affiliate program have the ability to restrict or enable specific affiliate or specific affiliate types based on filter criteria provided by both parties.

The RLS central server houses the RLS metatag database discussed above. The RLS central server also houses the RLS central repository which holds in a member profile database the information provided during sign up and as modified at subsequent times by members. This information is stored in a database form and includes, among other things, the practical identifications (logos) (see e.g. 723 and 724, FIG. 7), return URLs (e.g. 722), additional message line identifiers (e.g. 721) and other member profile information such as opt out information and instant affiliate information. Some of this information stored in the RLS central server 190 is located in what is called the worldwide logo and name registry. It should be noted that one of the benefits of the central repository is that an advertiser may make one easy adjustment in one location, i.e., the RLS central server 190 (FIG. 1), and instantly update the member's adverting all over the world each time the ads are subsequently displayed.

The RLS central server 190 in another embodiment includes the RLS history/demographics database. This RLS history/demographics database may be accessed by users 105 to see where other users 105 came from to get to the particular site that the user 105 is visiting. This is a very important search tool for helping the user find sites that may otherwise be elusive. This system is similar to known systems, such as, for example, Alexia and Amazon.com, which are herein incorporated by reference. However, a difference between the RLS and other systems is that the RLS stores the historical/demographical information in a data base repository on RLS's central server, instead of in the user's “cookie”. This assures that the information is accessible even if the user delete's his or her RLS based cookie from their local hard drive. Nevertheless, the invention may also include the storage of information in a “cookie” in various embodiments. The RLS history/demographics database is also accessed by members to view data about the traffic at their web site (150 or 160). Information available includes information about the amount of time users 105 were at their web site (150 or 160), what time they visited, how much time was spent on each page of a web site, where they came from, the success of advertisements being displayed, what types of advertisements were the most effective, where the users 105 went to, what the users 105 did while they were at their web site, whether the users 105 purchased anything, how much they spent while at their web site and any other desired information. Those familiar in the art of web page programming will understand that many other types of information may be tracked. The RLS database receives the historical/demographical information from client interaction with RLS sites. Such RLS sites send information about the user to the RLS database in real time. See, e.g. U.S. Pat. No. 6,009,410, Method and System For Presenting customized advertising to a user on the World Wide Web, and U.S. Pat. No. 5,855,008, Attention Brokerage, incorporated by reference. In another embodiment, privacy restrictions may limit what can be seen by users 105, and members may or may not be limited to certain information based upon the license or fee paid for the service.

The RLS central server 190 may be located in one central server which may be located, in one embodiment, within an RLS host site, or the central server may be divided up and shared through many servers and many locations throughout the world with redundancy for example by following the standard technology for replicated databases. See Microsoft SQL Server replication manager. The RLS central server could be located on one or more host sites or could be separate and independent of all host sites.

In another embodiment, The RLS system can also create a page on a RLS member's site that dynamically creates links in real-time to other RLS sites. The content of the link page can be site owner defined to include or exclude specific sites or industries, or “Best” value to customer or “Best” commission to site owner. This page increases the site owners presence on other sites by increasing click throughs, and creates instantaneous affiliations with other businesses, with or without site owners control, to maximize site owners income and link-affiliation. Therefore, if an RLS member wants to have a “Links” page on their site, RLS can generate one dynamically based on predefined criteria from the RLS member.

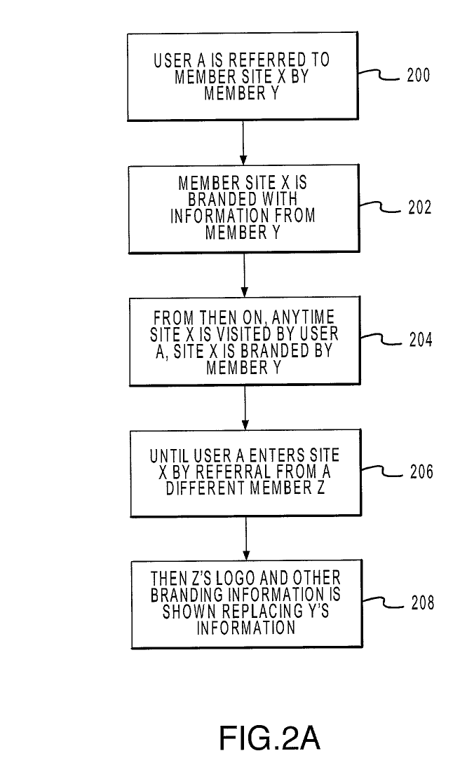

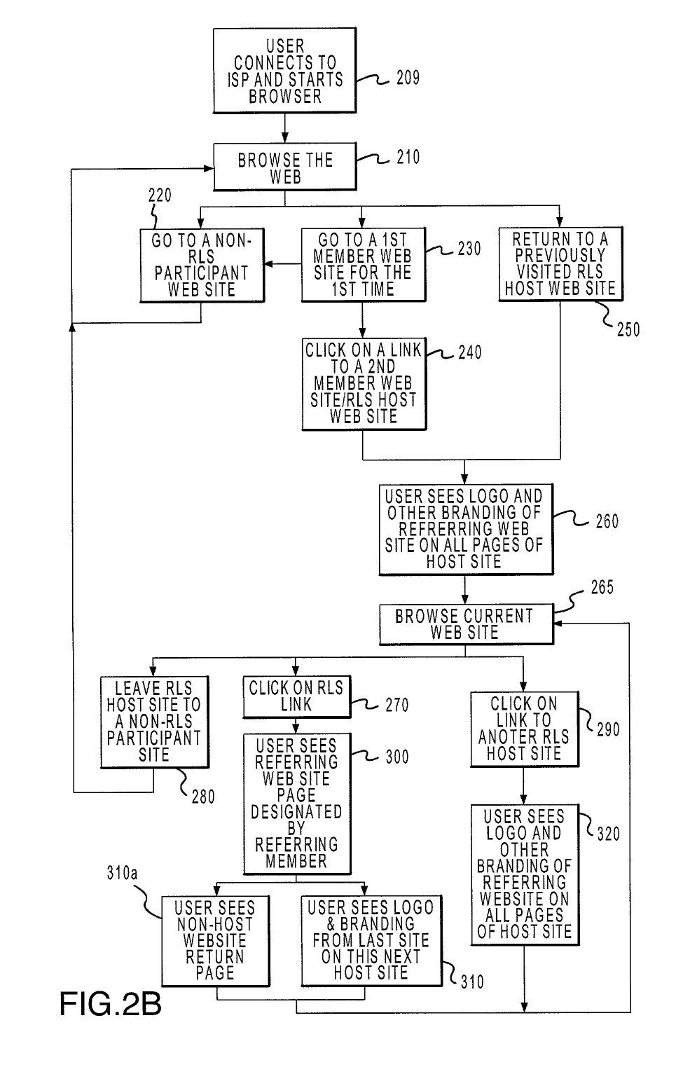

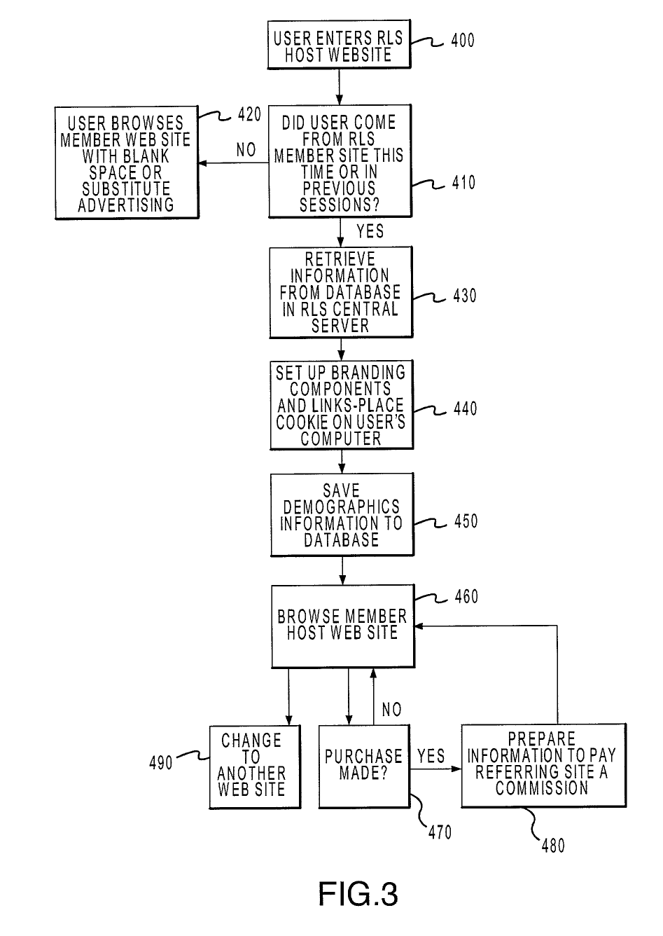

FIGS. 2 and 3 are flow diagrams illustrating exemplary logic for performing the return link system 100 (FIG. 1) functionality in accordance with the present invention. In an exemplary embodiment, the return link system may be accomplished automatically and without any modifications to the browser or software on user's computer 110 and the process can occur without the user 105 knowledge that an RLS system is being used to provide the results the user 105 views on the screen. In alternative embodiments, the browser may be modified to achieve some functions of the RLS system described herein.

Turning to FIG. 2A in an exemplary embodiment, user A is referred to member X's web site (Site X) by member Y (step 200). If referred from member Y's web site (Site Y), any means may be used to move from Site Y to Site X, for example, clicking on an ad/link, typing in a URL, using a book mark, or using a link from a selection of Favorite links. If user A is not referred to site X from another web site, identifying information must accompany the referral to identify member Y as the source of the referral. Such identifying information could be, for example, a password or member Identification number. Site X is then branded with member Y's logo, links to member Y's web site (site Y)(if applicable), a additional message line(s), and a greeting from member Y (step 202). From then on, every time site X is visited by user A, site X will show member Y's logo, link to site Y (if applicable), additional message line(s), and Y's greeting (step 204). This will continue until user A enters site X by referral from a different member Z (step 206). At this point, Z's logo, web site link (if applicable), and greeting are shown replacing the corresponding information from Y (step 208). All of the objects branding member Site X may function as return links to the referring web site. For example, if member Y's Logo is clicked, the user is returned to a web page indicated the profile of member Y. Similar results can be obtained by clicking on the greeting or additional message line(s). In alternative embodiments, less than all of the branding objects function as return links.

Any of the branding objects may serve the function of advertising for referring member Y or Z and effectively extend the referring member's session presence with users leaving the referring web site. In an exemplary embodiment, three branding objects are used: a logo, a additional message line, and a custom greeting. The Logo typically contains the name of the company, icons, or trademarks identifying the company, advertising, or other graphics and/or sound. The additional message line calls attention to special messages or pricing related to the referral. For example, the additional message line might read, “Internet special pricing courtesy of (referring Company Name)”. The custom greeting may contain any message from the referring web site or may be limited to a pre-defined set of greetings from which the referring web site may select a greeting. Although the present invention is described as utilizing three branding objects, it is understood that fewer or more objects could be used and that the name or purpose of the branding object can be modified.

In alternative embodiments, the branding of site X with member Y's logo may only last for a limited time specified by site owner X or some other limiting condition in the profiles of the members. In another exemplary embodiment, when user A enters site X from a different member Z's web site (site Z), information from both Z and Y is included on site X. In a further embodiment, if there is not enough space to show both the information for Z and the information for Y, a scrolling mechanism or other pull-down or similar system may be used.

Many alternative embodiments are contemplated in the present invention for showing the logo 520 (FIGS. 4b-c) and other information from a referring web site 500 (FIG. 4a). In one embodiment, one logo is displayed or available on a web site at any one time (see e.g. 515, FIG. 4b). In this embodiment, the current web site can show the logo of the first member web site to refer the user to the current web site. This first referral tracking can extend back through previous sessions by the same user, or alternatively be limited to only the user's current session. In another embodiment, the current web site shows the logo of the last web site to refer the user to the current web site.

In another embodiment, a current web site may show the logos of a chain of referring web sites. For example, if a user moves from host web site A to host web site B, and then subsequently to host web site C, the logos of both A and B can be displayed on web site C. In one embodiment these multiple web sites can be shown in order giving priority to the last web site that was visited before coming to the current web site and proceeding in lower order of priority to the first web site in the chain of referring web sites. In an alternative embodiment, that order may be reversed. In a further alternative embodiment, the order or priority of displaying the referring web site can be rotated during a session, thus giving each referring web site a period of time at the position of highest priority. In a further embodiment, this rotation of priority for the referring web sites in a chain of referring web sites could extend beyond the current session back through previous sessions. It should be noted that in all of these embodiments, due to the limitations of space, it may only be possible to view one logo at a time, relegating the other logos of lower priority to be viewed through the use of pull-down menus, scroll bars, or other similar technology.

In yet another embodiment for showing logos, links, and other objects only the direct links to the site are shown and not the other web sites in the chain of referring web sites. Nevertheless, it is contemplated that, if a user enters a web site through more than one referring web site, either during a current session or in different sessions, that multiple direct links to the site could be both displayed. In this situation, the alternative embodiments discussed above could also be implemented, namely ranking or prioritizing the web sites for preferential display. The alternative embodiments discussed with regard to the display of logos from referring web sites can be user definable and selectable, and are furthermore designed such that redundancies in logo display are eliminated.

Referring again to FIG. 2B, a user 105 connects to an Internet service provider and starts up a browser such as Internet Explorer® or Netscape® (step 209). The user next may browse the web (step 210) and it is assumed that during step 210 only non-RLS participant sites are visited. While browsing the web in step 210, the user takes one of three paths. First, the user may go to a non-RLS participant web site (140, FIG. 1) as shown in step 220. This will return the user automatically to previous step 210 where browsing the web continues. Second, the user may go to a first member web site for the first time and browse around within that web site and the pages associated with that web site (230) (see e.g. 500, FIG. 4a). At this point, the user may again go to a non-RLS participant web site (step 220, FIG. 2b) or the user may click on a link (see e.g. 510, FIG. 4a) at the first member's web site which refers the user to a second member's web site/RLS Host web site (step 240) (see e.g. 515, FIG. 4b). In other exemplary embodiments the user may type in the Uniform Resource Locator (URL), use a bookmark, use a pull-down menu from Favorites, or the like to reach either the first member web site or the second member web site.

The third path that a user 105 may follow from step 210 (FIG. 2b) is to return to a RLS Host web site that the user had visited previously in either this or an earlier session (step 250). Again, it is noted that user 105 may take step 250 by clicking on a link from a non-participating web site, selection from a list of favorites, use of bookmarks, or typing in a URL address. Regardless of whether the user takes the routes through steps 230 and 240 or through step 250, the user will see the logo of the referring web site on all of the pages of the current RLS Host web site the user is viewing (step 265). Displayed to the user in a predefined area is a logo (see e.g. 520, FIGS. 4b-d) sponsored by the referring web site, a custom greeting from the referring web site (see e.g. 524, FIGS. 4b-c), and/or an additional message line (see e.g. 522, FIGS. 4b-c). All, or less than all, of these objects may operate as links to the referring web site (if applicable). That referring web site is the first web site visited in step 230 (see e.g. 500, FIG. 4a) or the referring web site to the previously visited web site of step 250.

The referring web site has effectively extended its session presence by keeping a reminder of the referring web site and advertising in front of the user for a longer period of time. Presence is defined to mean any method of displaying or providing access to any web site and includes, but is not limited to, logos, text, coupons, hyperlinks, and the like. This ability to extend presence through multiple sessions and multiple generations of host sites visited is extremely valuable to advertising success.

The user 105 may browse all of the pages associated with the web site of step 265 and will see the logo (see e.g. 520, FIGS. 4b-d), greeting (see e.g. 524), and/or additional message line (see e.g. 522), of the referring web site; any or all of which may also be links to the referring web site on all of these subsequently visited pages (see e.g. 526, FIGS. 4c-d). The display of the logo and links of the referring web site is fully functional on all subsequent levels of names at a site's domain name, for example: www.sitel.com, www.marketing.sitel.com, www.ads.marketing.site1.com, etc. Furthermore, it is possible to specify multiple return points by causing the links at one level or web page to return to a different URL address than the links on another level or web page. The user 105 may continue to surf until one of three actions are taken: The user clicks on an RLS link (step 270) (see e.g. 520, 522, 524, FIGS. 4b-c), the user leaves the RLS Host site to a non-RLS participant site (step 280), or the user clicks on another member site (step 290). If the user clicks on a link or otherwise redirects the user's browser to a non-member site (step 280), the user will return to step 210.

If the user clicks on an RLS link (step 270), the user will be returned to a URL address designated by the referring web site (step 300) in its user profile stored on RLS central server 190 (FIG. 1) (see e.g. 501, FIG. 4e). Step 300 illustrates a particular advantage of the RLS system in facilitating the user to return to a previously visited web site in a simple manner. In the prior art, a BACK button could be used to sequentially step back through screens that had previously been visited or use a history tool to make larger jumps back in time sequentially to a web site that was previously visited. Both of these prior art methods can be slow, aggravating, prone to error, and even under the best of circumstances and with lots of patience can lead the user back to a portion of the web site which may no longer be appropriate for the user's needs. Step 300 allows user 105 to immediately, simply, and with one click return to the appropriate web page of the referring web site as determined by actions that have been taking place on the current web site. For example, if the user had just purchased a product at the current web site, it may be more appropriate to return to a specific web page on the referring web site where a message may be displayed providing the user with an incentive/discount, or other information such as advertising (see e.g. 501, FIG. 4e).

With further reference to FIG. 2B, when the user is returned to a referring host web site, the user will see the logo, the custom greeting, and/or additional message line of the previous web site of step 260 (step 310). If the user is returned to a non-host referring web site, the user will see whatever web page was designated in the URL return link in the central server profile. (step 310a) (see e.g. 501, FIG. 4e). In either case, the user will next return to step 265 as shown in FIG. 2.

If the user in step 265 clicks on a link to another host web site (step 290), the user will see branding information from the “new” referring web site on the “new” Host web site (step 320). In an exemplary embodiment, the user may also see the prior web sites visited up to N web sites with the ability to scroll to view links to web sites which will no longer fit in the predefined area for displaying logos and web sites. It should also be noted that the predefined area could be any size and placed anywhere on the web site. From step 320, the user would then return to step 265 where the user may continue browsing.

Referring now to FIG. 3, FIG. 3 is a flow diagram illustrating exemplary logic for performing the return link functionality from the perspective of a RLS Host site. A user enters the RLS Host site (step 400). The web site performs an operation (discussed in more detail below) to determine if the user came from a RLS Member site, or to determine if the user has previously visited this web site from an RLS Member site. (Step 410). If the user came from a non-RLS participant web site and has never visited this web site before from an RLS participant web site, the user may proceed to browse this web site and may see no advertising (“blank space”) in the space reserved for RLS Member branding information (Step 420). Alternatively, a member web site may display substitute advertising in the blank space. For example, the web site owner may contract with other companies to advertise products and services in the blank space. Furthermore, rather than individually sell the advertising on their own, web site owners can sign up for the Instant Affiliate program associated with the RLS system whereby the unused advertising space is filled up with advertisers selected based on preferences indicated by the web site owner in advance and automatically selected from a pool of potential advertisers as described in the discussion of the Instant Affiliates program above.

The host site may employ a number of methods to verify if the user came from an RLS Member web site; however, none of these methods require a change in the user's browser nor a change in the user's browsing methods. For example, it is well known in the art that it is possible to obtain information about the referring web site when a user clicks through to the new web site. It is also known in the art that technology exists for determining what web site (IP address) the user came from and cross-referencing that web site with a list of web sites (list of member IP addresses) that are members of the RLS system; thus determining whether the user did or did not come from a member web site. The RLS host web server, through standard web serving technology, recognizes the primary domain name of the referring web site and communicates that name to the RLS central repository, The RLS central repository will return information to the RLS host site as to whether the referring site is a registered RLS member, and if such, where to locate the logo to display, whether an instant referral commission affiliation is to be formed, etc. See e.g., U.S. Pat. No. 6,009,410, Method And System For Presenting Customized Advertising To A User In The World Wide Web, and U.S. Pat. No. 5,948,061, Method Of Delivery, Targeting, And Measuring Advertising Over Networks, incorporated by reference. In addition, step 410 can use well known technology to determine if the user had ever before visited this web site from a member web site. This can be accomplished by checking for an RLS cookie on the user's computer, or by alternative methods such as determining the IP (internet protocol) address, or other technology such as microchips with identification tags in them. Cookies are a technology that enables a web server to retrieve information from a user's computer that reveals prior browsing activities of the user. The information about the user's prior browsing activities is stored in a cookie which in one embodiment can be placed by a host site on the user's hard drive. Further information regarding the use of cookies can be found at http://www.cookiecentral.com and in Microsoft's MSDN, a monthly electronic subscription based CD from Microsoft that includes Microsoft's knowledge base on technology, including cookies, said reference being incorporated herein by reference. It should be noted that if the user has visited the web site before in a previous session or earlier in the current session but has clicked through to this web site, in one embodiment, the click through source will control and replace the cookie to guarantee that the return link will connect to the latest referring member web site. In an alternative embodiment, the first web site that refers a user to an RLS web site will always remain on top of the list of referring web sites or alternatively may be the only one ever displayed. In the event that it is determined in Step 410 that the entry to the web site was prompted by a member referral, the web site will next retrieve information from a database in the RLS central server 190 (FIG. 1) which contains logos, links, information regarding the placement of the logos and links, greeting messages, and/or other information supplied by the referring web site such as where the links should return the users, how many referring web sites can exist in the stack of logos, Instant Affiliate information, and other desired information. (Step 430). Next, the web page sets up the logos, links, additional message lines and/or greetings on the RLS web site, and places a cookie on the user's computer (Step 440). This cookie will identify the user and the fact that the user was referred from a specific web site such that every time that particular user visits this particular web site the cookie will correctly signal the web site to put the logo and advertisements up for that referring web site.

It should be understood that although the present embodiment has been described as using only one logo representing a first referring web site, it is contemplated that a plurality of web sites may be identified by logos and return links showing a history or chain of successive referrals from one member web site to the next and showing from 1 to N logos in reverse chronological order. It is also contemplated that the order of the web site can be rotated showing only one logo at a time but rotating periodically from one web site to the next which either directly and/or indirectly assisted in routing the user to that particular web site. It is also anticipated that in embodiments where more than one logo are displayed, the order of the display priority of these logos may be rotated, interchanged, or fixed.

Throughout the process of browsing on the RLS enabled web site, the clicks, purchases, and/or other actions of the user can be identified and recorded and information from that session may be transferred to a database where historical and demographical information may be recorded for further use. It is understood that information transferred to the database may be transferred either by a batch process or in real time. It is also understood that although this process of saving demographic and historical information to a database is identified as step 450, this process may take place at any time while the user is browsing on the RLS enabled web site, or after the user has left the RLS enabled web site. Step 450 may also take place at multiple points in time depending on the data to be transferred to or from the database. This demographic and historical information can be accessed by members for purposes such as, for example, marketing research and to evaluate the success of a web page's set up. This information may also be accessed by users as a search tool making known to the user how other users were referred to that host site.

The user continues browsing the pages of the member's web site (Step 460). If a purchase is made (Step 470), a host site communicates that fact and relevant information to the RLS central repository where a determination is made as to whether or not a fee is owed to the referring web site as a commission for the referral. This information is determined by referring to the member's profile and the selections regarding the Instant Affiliates and referral fees (Step 480). After the information is recorded regarding the payment of a commission to a referring web site, the user may continue browsing the pages of the member's web site, or alternatively, may be taken to a screen as specified by RLS preferences selected by the member web site or the referring member web site which may show a message thanking the user for the purchase or some other similar message. In an alternative embodiment, the crediting of sales may extend to both a first and a second referring member and according to terms defined in the RLS central server database.

The user remains on the member web site until either a link is clicked, an address is typed in, or some other event triggers the change from the member's web site to another member's web site, or to a non-member web site (Step 490). Also, the user may leave a member web site by clicking on one of the return link symbols shown on each page of the web site owner's web site and/or taking the user back to the referring web site. The return links can return the user to the page that the user was on before leaving the referring web site, or alternatively, the user may be returned to a particular page of the referring web site as designated in the preferences section and selected by the member. This presents the distinct advantage of being able to have a special message, advertisement and/or other goal to present to the user when the user returns to the referring web site. It is also possible to have multiple return links established, one for each page such that the user's return address depends upon the particular page of the referred web site that the user is on when a return link is clicked. This may also be set up by the referring web site member in the referring web site member's profile.

In one embodiment of the present invention, a “special offer” such as a discount or other incentive can be displayed in the additional message line for a limited time or alternatively the “special offer” can last until the link is replaced due to entering the web site from another member site. The RLS system creates the ability for merchants to do personalized advertising. Advertising can be directed to an individual user based on the interests expressed by the individual user through browsing habits. Special offers and incentives can be targeted to individuals most likely to be interested in a product and the level of incentive can be tailored to be great enough to encourage that particular user to purchase products. Therefore, the Return Link System is a very useful tool to encourage referrals, make advertising more efficient, simplify and encourage business affiliation, simplify browsing for users, extend session presence for web site owners, increase compensation to referring web sites, allow participation of non-web based participants, and identify affiliates for preferential treatment.

The corresponding structures, materials, acts and equivalents of all elements in the claims below are intended to include any structure, material, or acts or performing the functions in combination with other claimed elements as specifically claimed. The scope of the invention should be determined by the allowed claims and their legal equivalents, rather than by the examples given above.

What is claimed is:

1. A method for providing indicia on a web site comprising:
allowing a user system to access a host site, wherein said host site is located on a server;
determining if the user system was referred to said host site by a referring member;
retrieving information associated with said referring member from a referring member profile database; and,
displaying on said host site indicia sponsored by said referring member.

2. The method of claim 1, wherein said determining step further comprises at least one of the following steps:
identifying a cookie on said user system;
identifying an IP address of a referring web site and cross referencing said IP address with a list of member IP addresses; and
identifying an IP address of said user system and cross referencing said IP address with a list of user system IP addresses.

3. The method of claim 1, wherein said determining step further comprises:
placing a cookie on said user system.

4. The method of claim 1, wherein said displaying step further comprises at least one of the following steps:
displaying said at least one indicia on subsequent levels of pages within said host site;
retrieving and displaying information associated with said referring member from a RLS central repository;
said host site selectively blocking said at least one indicia from display for at least one of the following: said member, said member site, and groups of said member sites;
displaying a corresponding indicia for each referring web site; wherein more than one referring web sites are represented on said host site at a time;
displaying said corresponding indicia for less than all referring web sites;
utilizing pull down and scroll bar technology to see non-displayed indicia; and,
displaying said corresponding indicia for each referring web site in order of priority; wherein said priority is determined by at least one of:
chronologically prioritizing referring web sites with highest priority to a last referring web site,
chronologically prioritizing referring web sites with highest priority to a first referring web site, and
chronologically prioritizing referring web sites by dynamically rotating the highest priority among each referring web site.

5. The method of claim 1, wherein providing indicia on a web site includes providing at least one of the following: a logo, an additional message line, and a custom greeting.

6. The method of claim 1, further comprising the step of storing and retrieving demographics and history information from a demographics and history database and displaying said information to members.

7. The method of claim 6 wherein said demographics and history information is displayed as a list of other referring web sites that referred other users to said host site; and wherein said selection is also displayed to said user system.

8. The method of claim 1, further comprising the step of registering a RLS Member by at least one of the following:
receiving at said host site, from a potential RLS Member, information identifying said member and information facilitating the subsequent display on said host site of said at least one indicia;
receiving at an RLS Central Server, from a potential RLS Member, information identifying said member and information facilitating the subsequent display on said host site of said at least one indicia;
receiving an indication of a desire by said member to operate as a host site;
receiving specifications regarding positioning of said at least one indicia on said member's own site;
receiving specifications regarding the URL of one of said at least one indicia, said at least one indicia being a logo;
creating a logo for said RLS member;
receiving an indication of a desire by said member to participate with a web site;
receiving specifications regarding a return link destination;
receiving specifications regarding an additional message line; and
receiving specifications regarding a custom greeting.

9. The method of claim 8, further using said indicia to return said user system from said host site to said return link destination.

10. The method of claim 1, further comprising at least one of the following steps:
providing at least one RLS metatag as a weighting factor for at least one other search engine;
providing a standard metatag format in an RLS metatag database for downloading to a user system; and,
providing a RLS favoring search engine on said host site.

11. The method of claim 1, further comprising the step of providing an instant affiliates program wherein said instant affiliates program further includes at least one of the following steps:
receiving a criteria for permitting instant affiliation;
creating an affiliate based on said criteria for permitting instant affiliation;
receiving a criteria for prioritizing affiliations;
creating an affiliate based on said criteria for prioritizing affiliations;
searching the network for at least one RLS Member and saving found information in an RLS central server;
creating a links page on said host site for automatically affiliating members based on predefined criteria; and,
advertising on said host site by said affiliate.

12. The method of claim 11, further including the step of providing remuneration to said referring member for at least one of the following: a click-through; an impression; and a purchase.

13. A system for providing indicia on a web site, said system comprising:
a user system configured to access a host site, wherein said host site is located on a server; wherein said user system is referred to said host site by a referring member;
said host site configured to retrieve information associated with said referring member from a referring member profile database; and,
said host site configured to display indicia sponsored by said referring member.

14. The system of claim 13, wherein said system further comprises at least one of the following:
said host site configured to identify a cookie on said user system;
said host site configured to identify an IP address of a referring web site and cross reference said IP address with a list of member IP addresses; and
said host site configured to identify an IP address of said user system and cross reference said user system IP address with a list of user system IP addresses.

15. The system of claim 13, wherein said system further comprises:
said host site configured to place a cookie on said user system.

16. The system of claim 13, wherein said system further comprises at least one of the following:
said host site configured to display said at least one indicia on subsequent levels of pages at a domain name of said host site;
said host site configured to retrieve and display information associated with said referring member from a RLS central repository configured to contain a world wide logo and name registry;
said host site configured to selectively display said at least one indicia sponsored by at least one of the following: a specific member, a specific member site, and groups of member sites;
said host site configured to display a corresponding indicia for each referring web site; wherein at least one referring web site is represented on said host site at a time;
said host site configured to display said corresponding indicia for less than all referring web sites;
wherein pull down and scroll bar technology are used to see non-displayed indicia; and
said host site configured to display said corresponding indicia for each referring web site in order of priority; wherein said host site configured to prioritize said referring web sites by at least one of:
chronologically prioritizing referring web sites with highest priority to a last referring web site,
chronologically prioritizing referring web sites with highest priority to a first referring web site, and
chronologically prioritizing referring web sites by dynamically rotating the highest priority among each referring web site.

17. The system of claim 13, wherein said at least one indicia further comprises at least one of the following: a logo, an additional message line, and a custom greeting.

18. The system of claim 13, further comprising said host site configured to store and retrieve demographics and history information from said demographics and history database and display said information to members.

19. The system of claim 18 wherein said host site is configured such that said information is a list of other referring web sites that referred other user systems to said host site; and wherein said information is also configured for display to said user system.

20. The system of claim 13, said host site further configured with a registration system to register a RLS Member by at least one of the following:
said host site configured to receive from a potential RLS Member information identifying said potential RLS Member and information facilitating the subsequent display on said host site of said at least one indicia; and
said host site configured to link said potential RLS Member to a RLS Central Server configured to receive from said potential RLS Member information identifying said member and information facilitating the subsequent display on said host site of said at least one indicia.

21. The system of claim 20, wherein said registration system is further configured to do at least one of the following:
receive an indication of a desire by said member to operate as a host site;
receive specifications regarding positioning of said at least one indicia on said member's own site; and
receive specifications regarding the URL of one of said at least one indicia, said at least one indicia being a logo; and
create a logo for said RLS member.
receive an indication of a desire by said member to participate with a web site;
receive specifications regarding a return link destination;
receive specifications regarding an additional message line; and
receive specifications regarding a custom greeting.

22. The system of claim 21, wherein said indicia is configured to return said user system from said host site to said return link destination.

23. The system of claim 13, said system further configured to provide an instant affiliates program wherein said instant affiliates program is further configured to do at least one of the following:
receive a criteria for permitting and prioritizing advertising;
search the network for at least one RLS Member and save found information in an RLS central server;
create an affiliate based on said criteria for permitting and prioritizing advertising;
create a links page on said host site to automatically affiliate members based on predefined criteria; and,
advertise on said host site by said affiliate.

24. The system of claim 13, further configured to provide a RLS favoring search engine on said host site.

25. The system of claim 13, further configured to provide remuneration to said referring member for at least one of the following: a click-through; an impression; a purchase.

26. A system for providing indicia on a web site, said system comprising:
a RLS Central Server configured to be accessed by a user system, and a RLS member, and a host site, wherein said host site is located on a server; and wherein said user system is referred to said host site by a referring member;
said RLS Central Server configured with a referring member profile database to provide to said host site information associated with said referring member; and
wherein said information associated with said referring member comprises indicia sponsored by said referring member for display on said host site.

27. The system of claim 26, wherein said system further comprises said RLS Central Server configured to provide at least one of the following:
a list of member IP addresses for cross reference with an IP address of a referring web site to said host site; and
a list of user system IP addresses for cross reference with an IP address of said user system.

28. The system of claim 26, wherein said system further comprises at least one of the following:
said RLS Central Server configured to store and provide to said host site said indicia configured for display on subsequent levels of pages within said host site;
said RLS Central Server further configured with a RLS central repository configured to store and provide to said host site information associated with said referring member; and,
said RLS Central Server configured to receive updates from a RLS member and to store and provide to said host site filtered information to selectively display said indicia; wherein a non-displayed member is at least one of the following: a specific member, a specific member site, and groups of member sites.

29. The system of claim 26, said system further comprising said RLS Central Server configured to receive and store a set of indicia display information from said RLS members; and further configured to provide said set of indicia display information to said host site; wherein said set of indicia display information includes at least one of the following:
said set of indicia display information configured to indicate a number of referring web sites, up to all referring web sites, that are displayed on said host site at any time;
said set of indicia display information further configured to indicate whether pull down and scroll bar technology is to be used to view non-displayed indicia; and
said set of indicia display information configured to indicate a preferred order of priority for display of said number of referring web sites; wherein said preferred order may be specified as at least one of the following:
chronologically prioritizing referring web sites with highest priority to a last referring web site,
chronologically prioritizing referring web sites with highest priority to a first referring web site,
chronologically prioritizing referring web sites by dynamically rotating the highest priority among each referring web site.

30. The system of claim 26, wherein said at least one indicia further comprises at least one of the following: a logo, an additional message line, and a custom greeting.

31. The system of claim 26, further comprising said RLS Central Server configured with a demographics and history database configured to:
receive and store demographics and history information provided by said host site;
provide a selection of demographics and history information to said RLS members;
receive and store a list of other referring web sites that referred other user systems to said host site; and to provide said list of other referring web sites to said user systems at said host site.

32. The system of claim 26, said RLS Central Server further configured with at least one of the following:
a registration system configured to receive and store a set of registration information from a potential RLS Member said set of registration information identifying said member and facilitating the subsequent display on said host site of said at least one indicia; and
wherein said registration system is further configured to do at least one of the following:
receive, store, and provide an indication of a desire by said member to operate as a host site;
receive, store and provide specifications regarding positioning of said at least one indicia on said member's own site;
receive, store and provide specifications regarding the URL of one of said at least one indicia, said at least one indicia being a logo;
create a logo for said RLS member;
receive an indication of a desire by said member to participate with a web site;
receive, store and provide specifications regarding a return link destination;
receive, store and provide specifications regarding an additional message line; and
receive, store and provide specifications regarding a custom greeting.

33. The system of claim 26, said system further configured to provide an instant affiliates program wherein said instant affiliates program is further configured to do at least one of the following:
receive a criteria for permitting and prioritizing advertising;
search the network for at least one RLS Member and save found information in an RLS central server;
create an affiliate based on said criteria for permitting and prioritizing advertising; and
advertise on said host site by said affiliate.

34. The system of claim 26, wherein said RLS Central Server is further configured to provide remuneration to said referring member for at least one of the following: a click-through; an impression; a purchase.

35. A method for providing an instant affiliates program comprising:
allowing a user system to access a host site, wherein said host site is located on a server;
determining if the user system was referred to said host site by a referring member;
retrieving information associated with said referring member from a referring member profile database;
receiving a criteria for permitting instant affiliation; and,
wherein said instant affiliates program further includes at least one of the following steps:
creating an affiliate based on said criteria for permitting instant affiliation;
receiving a criteria for prioritizing affiliations;
creating an affiliate based on said criteria for prioritizing affiliations;
searching the network for at least one RLS Member and saving found information in an RLS central server;
creating a links page on said host site for automatically affiliating members based on predefined criteria; and,
advertising on said host site by said affiliate.

36. A method for providing indicia on a web site comprising:
allowing a user system to access a host site;
determining if the user system was referred to said host site by a referring member;
retrieving information associated with said referring member from a referring member profile database;
displaying on said host site indicia sponsored by said referring member;
displaying said indicia on subsequent levels of pages within said host site;
displaying said indicia on subsequent visits to said host site by said user system;
retrieving and displaying information associated with said referring member from a RLS central repository;
storing and retrieving demographics and history information from a demographics and history database and displaying said information to members;
registering a RLS Member;
using said indicia to return said user system from said host site to said return link destination;
providing an instant affiliates program wherein said instant affiliates program further includes at least one of the following steps:
receiving a criteria for permitting instant affiliation;
creating an affiliate based on said criteria for permitting instant affiliation; and,
providing remuneration to said referring member for at least one of the following:
a click-through; an impression; and a purchase.
